(19) United States
(12) Patent Application Publication
(10) Pub. No.: US 2007/0215469 A1
(43) Pub. Date: Sep. 20, 2007

(54) Gas sensor element with increased durability and related manufacturing method

(75) Inventor: Shinichiro Imamura, Chiryu-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/705,743

(22) Filed: Feb. 14, 2007

(30) Foreign Application Priority Data
Mar. 17, 2006 (JP) 2006-074269

(51) Int. Cl. G01N 27/26

(52) U.S. Cl. 204/424

(57) ABSTRACT

A gas sensor element and a related manufacturing method are disclosed. The gas sensor element comprises a solid electrolyte body 11, having oxygen ion conductivity, which has both surfaces formed with a measuring gas detecting electrode and a reference gas detecting electrode, respectively, and a porous layer, covering the measuring gas detecting electrode and permeating measuring gases, which is formed using a porous layer green sheet containing fibrous organic materials, oriented in a direction substantially perpendicular to a thickness direction thereof, which are caused to burn down to form a coarse layer with large porosity in one area closer to the solid electrolyte and a dense layer with less porosity than that of the coarse layer in the other area remote from the solid electrolyte body to provide capability of permeating measuring gases in a direction perpendicular to a thickness direction of the porous layer.

### CROSS REFERENCE TO RELATED APPLICATIONS

This application is based on Japanese Patent Application No. 2006-74269, filed on Mar. 17, 2006, the content of which is hereby incorporated by reference.

### BACKGROUND OF THE INVENTION

1. Field of the invention

The present invention relates to gas sensors for detecting a concentration of specified gas in measuring gases and, more particularly, to a gas sensor element for a gas sensor to be used in controlling combustion of an air fuel mixture in an internal combustion engine such as an automotive engine and a method of manufacturing the gas sensor element.

2. Description of the Related Art

In modern internal combustion engines, for the purpose of performing combustion control in an automotive engine, attempts have heretofore been made for gas sensors to be installed on exhaust systems of internal combustion engines of motor vehicles for detecting an oxygen concentration in exhaust gases.

The gas sensors usually employ gas sensor elements, respectively, a typical example of which is shown in FIG. 13. As shown in FIG. 13, the gas sensor element usually includes a solid electrolyte body 91 having oxygen ion conductivity, and a detecting section composed of a measuring gas detecting electrode 92, formed on one side of the solid electrolyte body, and a reference gas detecting electrode 93, formed on the other side of the solid electrolyte body, for detecting measuring gases.

The gas sensor includes an A/F sensor incorporating the gas sensor element with such a structure mentioned above. A voltage is plied across the measuring gas detecting electrode 92 and the reference gas detecting electrode 93 to cause electric current to flow through both of these electrodes for thereby detecting a specified gas (oxygen) concentration in measuring gases (exhaust gases). The A/F sensor is liable to operate with the occurrence of fluctuation in output depending on the rate of measuring gases being supplied to the measuring gas detecting electrode 92. Therefore, a need arises for measuring gases to be supplied at a regulated speed. To this end, an attempt has heretofore been made to stack a diffusion resistance layer 94 on a measuring gas chamber forming layer 96, formed on the solid electrolyte body 91, which has a central area formed with a measuring gas chamber 96a to which the measuring gas detecting electrode 92 is exposed (see Japanese Patent Application Publication No. 2005-337787.

With the diffusion resistance layer 94 made of a porous body, a need arises for the diffusion resistance layer to have a fixed diffusion resistance distance for measuring gases to permeate under a diffused state from an outer sidewall of the diffusion resistance layer 94 to the measuring gas detecting electrode 92. To ensure such a purpose, the gas sensor element 9 includes a shielding layer 95, formed on a surface of the diffusion resistance layer 94 in opposition to the solid electrolyte body 91, which does not permeate measuring gases.

However, the provision of the shielding layer 95 results in an increase in the number of man-hour and an increase in material costs.

Further, the gas sensor has an application as an O₂ sensor, operative to generate an electromotive force depending on a difference in oxygen concentration between the measuring gas detecting electrode and the reference gas detecting electrode for thereby detecting an oxygen concentration in measuring gases. Such O₂ sensor usually includes a protective layer, made of porous material, which is formed in a pattern so as to cover the measuring gas detecting electrode. The protective layer plays a role as a member to capture toxic substances in measuring gases for thereby protecting the measuring gas detecting electrode from degradation due to the presence of toxic substances.

However, as measuring gases containing toxic substances are introduced from the protective layer in a thickness direction thereof, toxic substances are liable to accumulate on the protective layer, causing an issue to arises with the occurrence of clogging in the protective layer.

### SUMMARY OF THE INVENTION

The present has been completed with a view to addressing the above issues and has an object to provide a gas sensor element, which is easy to be manufactured at low cost and has excellent durability with high detecting precision, and related manufacturing method.

To achieve the above object, a first aspect of the present invention provides a gas sensor element comprising a solid electrolyte body having oxygen ion conductivity, a measuring gas detecting electrode formed on one surface of the solid electrolyte body, a reference gas detecting electrode formed on the other surface of the solid electrolyte body, and a porous layer covering the measuring gas detecting electrode and permeating measuring gas thereto. The porous layer includes a coarse layer with a large porosity formed in close proximity to the solid electrolyte body and a dense layer, having a porosity less than that of the porosity of the coarse layer, which is formed in an area away from the coarse layer with respect to the solid electrolyte body.

With such a structure of the gas sensor element, the porous layer has the coarse layer formed in an area closer to the solid electrolyte body and the dense layer formed in the other area remote from the solid electrolyte body. This blocks the entry of measuring gases through the porous layer in the thickness direction thereof, permitting measuring gases to penetrate through the porous layer at the sidewall thereof in a direction substantially perpendicular to the thickness direction of the porous layer. Therefore, the porous layer can maintain a substantially fixed diffusion distance for measuring gases to reach the measuring gas detecting electrode. This results in capability of obtaining a gas sensor element that achieves the stabilization of sensor output with increased detecting precision.

In addition, the porous layer can permeate measuring gases in the substantially fixed diffusion distance without causing a dense shielding layer to be separately provided on a surface of the porous layer, enabling reductions in the number of man-hour and material costs.

As set forth above, further, since the porous layer has the coarse layer formed in the area closer to the solid electrolyte body and the dense layer formed in the other area remote from the solid electrolyte body, the clogging of the porous layer resulting from toxic substances in measuring gases permeating through the porous layer can be prevented in a reliable fashion. That is, as mentioned above, since the porous layer allows measuring gases to be introduced not from the thickness direction of the porous layer but from the sidewall thereof, toxic substances contained in measuring gases can be prevented from accumulating in the porous layer for thereby preventing the clogging of the porous layer. This results in capability of providing a gas sensor element with increased durability.

Further, there are probabilities where water droplets, coming by air with measuring gases, adhere onto a surface of the gas sensor element. However, since the porous layer has an outer surface formed with the dense layer, the gas sensor element can have increased strength. Therefore, the cracking of the gas sensor element, caused by thermal shocks resulting from the adhesion of water droplets, can be reliably prevented. This results in capability of obtaining a gas sensor element with increased durability.

As set forth above, the present invention enables the provision of a gas sensor element that can be easily manufactured with a reduction in material costs while having excellent durability with increased detecting precision.

A second aspect of the present invention provides a gas sensor element comprising a solid electrolyte body having oxygen ion conductivity, a measuring gas detecting electrode formed on one surface of the solid electrolyte body, a reference gas detecting electrode formed on the other surface of the solid electrolyte body, and a porous layer covering the measuring gas detecting electrode and permeating measuring gas thereto. The porous layer has gas permeability mainly in a direction substantially perpendicular to a thickness direction of the porous layer.

With the gas sensor element mentioned above, the porous layer mainly has permeability only in the direction substantially perpendicular to the thickness direction of the porous layer, measuring gases can reach the measuring gas detecting electrode upon passing through a diffusion distance lying at a substantially fixed value without providing a separate shielding layer. This enables reductions in the number of man-hour and material costs while ensuring increased detecting precision.

Further, since the porous layer mainly has permeability only in the direction substantially perpendicular to the thickness direction of the porous layer, the porous layer can admit measuring gases not from the thickness direction but from the sidewall. Therefore, like the gas sensor element of the first aspect of the present invention, the gas sensor element of the second aspect of the present invention can prevent toxic substances, contained in measuring gases, from accumulating in the porous layer to avoid the occurrence of clogging. This enables the provision of a gas sensor element that is excellent in durability.

As set forth above, the second aspect of the present invention provides an ease of production of the gas sensor element that has excellent durability with increased detecting precision while enabling a reduction in material costs.

A third aspect of the present invention provides a gas sensor element comprising a solid electrolyte body having oxygen ion conductivity, a measuring gas detecting electrode formed on one surface of the solid electrolyte body, a reference gas detecting electrode formed on the other surface of the solid electrolyte body, a duct forming layer formed on the other surface of the solid electrolyte body and having a reference gas chamber to which the reference gas detecting electrode is exposed, and a porous layer covering the measuring gas detecting electrode and having a coarse layer with a large porosity formed in an area close proximity to the solid electrolyte body and a dense layer, having a porosity less than that of the porosity of the coarse layer, which is formed in another area away from the coarse layer with respect to the solid electrolyte body. The porous layer has at least one sidewall communicating with the coarse layer and the dense layer through which measuring gases are introduced from an outside measuring gas atmosphere to the measuring gas detecting electrode mainly in a direction substantially perpendicular to a thickness direction of the porous layer.

With such a structure of the gas sensor element, the porous layer has the side wall communicating with the coarse layer formed in the area closer to the solid electrolyte body and the dense layer formed in the other area remote from the solid electrolyte body. This blocks the entry of measuring gases through the porous layer in the thickness direction thereof, permitting measuring gases to penetrate through the porous layer at the sidewall thereof in a direction substantially perpendicular to the thickness direction of the porous layer. Therefore, the porous layer enables measuring gases to reach the measuring gas detecting electrode in a substantially fixed diffusion distance. This makes it possible to obtain a gas sensor element that is stabilized in sensor output with an increase in detecting precision.

Further, measuring gases can permeate through the porous layer in the substantially fixed diffusion distance without causing a dense shielding layer to be separately located on a surface of the porous layer, enabling reductions in the number of man-hour and material costs.

As set forth above, furthermore, since the porous layer has the coarse layer with the large porosity and the dense layer with the porosity less than that of the coarse layer, the gas sensor element is free from the occurrence of clogging caused in the porous layer resulting from toxic substances contained in measuring gases permeating through the porous layer. That is, as mentioned above, measuring gases can be introduced through the porous layer not from the thickness direction but from the sidewall thereof. Thus, the accumulation of toxic substances in the porous layer can be effectively avoided, thereby preventing the clogging of the porous layer in a highly reliable manner. Thus, it becomes possible to obtain a gas sensor element that can be easily manufactured with reductions in the number of man-hour and material costs while achieving increased durability.

Moreover, the porous layer has an outer surface formed with the dense layer with no water droplets penetrating through the outer surface of the porous layer, thereby permitting the gas sensor element to have increased strength. This allows the gas sensor element to have increased resistance in thermal shocks resulting from the adhesion of water droplets, thereby effectively preventing the occurrence of cracking in component parts of the gas sensor element. This enables the provision of a gas sensor element having increased durability.

A fourth aspect of the present invention provides a gas sensor element comprising a solid electrolyte body having oxygen ion conductivity, a measuring gas detecting electrode formed on one surface of the solid electrolyte body, and a reference gas detecting electrode formed on the other surface of the solid electrolyte body. A duct forming layer is formed on the other surface of the solid electrolyte body and has a reference gas chamber to which the reference gas detecting electrode is exposed. A measuring gas chamber forming layer is formed on the other surface of the solid electrolyte body and has a measuring gas chamber to which the measuring gas detecting electrode is exposed. A diffusion resistance layer is formed on the measuring gas chamber forming layer, and a porous layer covering the diffusion resistance layer. The porous layer includes a coarse layer with a large porosity formed in an area close proximity to the diffusion resistance layer and a dense layer, having a porosity less than that of the porosity of the coarse layer, which is formed in another area away from the coarse layer with respect to the diffusion resistance layer. The porous layer has at least one sidewall communicating with the coarse layer and the dense layer through which measuring gases are introduced from an outside measuring gas atmosphere mainly in a direction substantially perpendicular to a thickness direction of the porous layer. The diffusion resistance layer has at least one pinhole providing fluid communication between the coarse layer of the porous layer and the measuring gas chamber to introduce the measuring gases to the measuring gas detecting electrode.

With the gas sensor element according to the fourth aspect of the present invention mentioned above, the diffusion layer, formed with the pinhole, is stacked on the solid electrolyte body via the measuring gas chamber forming layer and is covered with the porous layer in communication with the pin hole. The porous layer has the coarse layer in an area closer to the diffusion resistance layer and the dense layer formed in the other area remote from the diffusion resistance layer. The porous layer mainly has permeability only in the direction substantially perpendicular to the thickness direction of the porous layer. This enables measuring gases to pass through the porous layer in a substantially fixed diffusion distance without providing a separate shielding layer on the porous layer and pass through the pinhole of the diffusion resistance layer to reach the measuring gas detecting electrode. This enables reductions in the number of man-hour and material costs while ensuring increased detecting precision.

Further, since the porous layer mainly has permeability only in the direction substantially perpendicular to the thickness direction of the porous layer, the porous layer can admit measuring gases not from the thickness direction but from the sidewall. Thus, the gas sensor element of the fourth aspect of the present invention can prevent toxic substances, contained in measuring gases, from accumulating in the porous layer to avoid the occurrence of clogging. This enables the provision of a gas sensor element that is excellent in durability.

A fifth aspect of the present invention provides a gas sensor element comprising a sensor cell including a first solid electrolyte body having oxygen ion conductivity, a measuring gas detecting electrode formed on one surface of the first solid electrolyte body, a reference gas detecting electrode formed on the other surface of the first solid electrolyte body, and a duct forming layer formed on the other surface of the first solid electrolyte body and having a reference gas chamber to which the reference gas detecting electrode is exposed. A pump cell is stacked on the sensor cell and includes a second solid electrolyte body, a first pumping electrode formed on one surface of the second solid electrolyte body, a second pumping electrode formed on the other surface of the second solid electrolyte body, and a measuring gas chamber forming layer interposed between the first and second solid electrolyte bodies and having a measuring gas chamber to which the measuring gas detecting electrode and the second pumping electrode are exposed, and a porous layer formed on the one surface of the second solid electrolyte body so as to cover the first pumping electrode and having a coarse layer with a large porosity formed in an area close proximity to the second solid electrolyte body and a dense layer, having a porosity less than that of the porosity of the coarse layer, which is formed in another area away from the coarse layer with respect to the second solid electrolyte body. The porous layer has at least one sidewall communicating with the coarse layer and the dense layer through which measuring gases are introduced from an outside measuring gas atmosphere mainly in a direction substantially perpendicular to a thickness direction of the porous layer. The second solid electrolyte body has at least one pinhole providing fluid communication between the coarse layer of the porous layer and the measuring gas chamber to introduce the measuring gases to the measuring gas detecting electrode.

With the fifth aspect of the present invention, the gas sensor element comprises the sensor cell and the pump cell on which the sensor cell is stacked. The sensor cell includes the first solid electrolyte body having oxygen ion conductivity, the measuring gas detecting electrode formed on one surface of the first solid electrolyte body, the reference gas detecting electrode formed on the other surface of the first solid electrolyte body, and the duct forming layer formed on the other surface of the first solid electrolyte body and having a reference gas chamber to which the reference gas detecting electrode is exposed.

The pump cell includes the second solid electrolyte body, the first pumping electrode formed on one surface of the second solid electrolyte body, the second pumping electrode formed on the other surface of the second solid electrolyte body and the porous layer formed on the one surface of the second solid electrolyte body so as to cover the first pumping electrode.

The use of such a structure enables measuring gases to permeate through the porous layer having the coarse layer with a large porosity and the dense layer having a less porosity than that of the porosity of the coarse layer in a direction substantially perpendicular to the thickness direction of the porous layer.

Thus, measuring gas arrived at the first pumping electrode pass through the pinhole formed in the second solid electrolyte body to the measuring gas detecting electrode. Measuring gases travel through the porous layer in the direction substantially parallel to the thickness direction in the substantially fixed diffusion distance without employing a separate protective layer provided on the porous layer, enabling reductions in the number of man-hour and material costs while having increased durability with high precision in detecting function.

A sixth aspect of the present invention provides a gas sensor element comprising a sensor cell including a first solid electrolyte body having oxygen ion conductivity, a measuring gas detecting electrode formed on one surface of the first solid electrolyte body, a reference gas detecting electrode formed on the other surface of the first solid electrolyte body, and a duct forming layer formed on the other surface of the first solid electrolyte body and having a reference gas chamber to which the reference gas detecting electrode is exposed. A pump cell is stacked on the sensor cell and includes a second solid electrolyte body, a first pumping electrode formed on one surface of the second solid electrolyte body, a second pumping electrode formed on the other surface of the second solid electrolyte body, and a measuring gas chamber forming layer interposed between the first and second solid electrolyte bodies and having a measuring gas chamber to which the measuring gas detecting electrode and the second pumping electrode are exposed, and a porous layer formed on the one surface of the second solid electrolyte body so as to cover the first pumping electrode and having a coarse layer with a large porosity formed in an area close proximity to the second solid electrolyte body and a dense layer, having a porosity less than that of the porosity of the coarse layer, which is formed in another area away from the coarse layer with respect to the second solid electrolyte body. The porous layer comprises a porous layer having a coarse layer with a large porosity and a dense layer having a porosity less than that of the porosity of the coarse layer and having at least one sidewall communicating with the coarse layer and the dense layer through which measuring gases are introduced to the measuring gas chamber from an outside measuring gas atmosphere mainly in a direction substantially perpendicular to a thickness direction of the porous layer of the measuring gas chamber forming layer.

With the sixth aspect of the present invention, the gas sensor element comprises the sensor cell, the pump cell on which the sensor cell is stacked, and the diffusion resistance layer, made of a porous layer with the same structure as that of the porous layer of the pump cell, which is sandwiched between the sensor cell and the pump cell. The measuring gas chamber is formed in an internal area of the diffusion resistance layer sandwiched between the sensor cell and the pump cell. This allows measuring gases to pass through the diffusion resistance layer, composed of the porous layer, in the direction substantially perpendicular to the thickness direction of the diffusion resistance layer. Thus, measuring gases can travel through the diffusion resistance layer in the substantially fixed diffusion distance without causing a need to provide an additional protecting layer. This results in reductions in the number of man-hour and material costs, enabling a reduction in production cost yet achieving an increase in precision in detecting function.

A seventh aspect of the present invention provides a method of manufacturing a gas sensor element, the method comprising the steps of (a) preparing a solid electrolyte body, having oxygen ion conductivity, which has one surface formed with is a measuring gas detecting electrode and the other surface formed with a reference gas detecting electrode, and (b) covering the measuring gas detecting electrode with a porous layer. The porous layer is formed by forming a porous layer green sheet using a porous layer forming slurry mixed with fibrous organic materials, orienting the fibrous organic materials in a direction substantially perpendicular to a thickness direction of the porous layer green sheet, and firing the porous layer green sheet while burning down the fibrous organic materials.

With the gas sensor element manufacturing method according to the seventh aspect of the present invention, the porous layer green sheet is formed using porous layer forming slurry mixed with the fibrous organic materials. This allows the fibrous organic materials to be oriented in a direction substantially perpendicular to the thickness direction of the porous layer green sheet. Under such a state, the porous layer green sheet is fired to cause the fibrous organic materials to be burned down. This allows pores to be formed in areas where the fibrous organic materials were present. Therefore, the resulting pores take elongated configurations oriented in directions substantially perpendicular to the thickness direction of the porous layer.

As a result, the resulting porous layer mainly has gas permeability only in a direction substantially perpendicular to the thickness direction of the porous layer. Thus, no need arises for an additional protecting layer to be provided on the porous layer. This results in an ease of production and a reduction in material costs, enabling the provision of a gas sensor element with excellent durability and increased detecting precision.

As set forth above, the seventh aspect of the present invention can provide a method of easily manufacturing a gas sensor element that is low in material costs and has excellent durability with increased detecting precision.

An eighth aspect of the present invention provides a method of manufacturing a gas sensor element, the method comprising the steps of (a) preparing a solid electrolyte body, having oxygen ion conductivity, which has one surface formed with a measuring gas detecting electrode and the other surface formed with a reference gas detecting electrode, and (b) forming a porous layer so as to cover the measuring gas detecting electrode. The porous layer forming step (b) includes the steps of (c) solidifying binders in a porous layer forming slurry to form solidified organic materials, (d) drying the porous layer forming slurry and kneading the same to form a green clay body and subsequently processing the solidified organic materials into fibrous organic materials, (e) shaping the green clay body into a porous layer green sheet to cause the fibrous organic materials to be oriented in a direction substantially perpendicular to a thickness direction of the porous layer green sheet, and (f) firing the porous layer green sheet while burning down the fibrous organic materials.

Even with the gas sensor element manufacturing method according to the eighth aspect of the present invention, after completed firing step, the porous layer green sheet has the pores formed in the areas where the fibrous organic materials were present. The pores have elongated configurations oriented in directions substantially perpendicular to the thickness direction of the porous layer. Therefore, the resulting porous layer mainly has gas permeability only in the direction substantially perpendicular to the thickness direction. This allows measuring gases to permeate through the porous layer in the substantially fixed diffusion distance with no need arising for a separate protecting layer to be provided on the porous layer. This enables the provision of an ease of manufacturing a gas sensor element that is low in materials costs and has increased detecting precision.

As set forth above, the eighth aspect of the present invention can provide a method of manufacturing a gas sensor element that is easily manufactured, low in material costs, high in durability and high in detecting precision.

### BRIEF DESCRIPTION OF THE DRAWINGS

FIG. 1 is a cross sectional view showing a gas sensor element of a first embodiment according to the present invention.

FIG. 2 is a cross sectional view showing a porous layer used in the gas sensor element of the first embodiment sown in FIG. 1.

FIG. 3 is an exploded perspective view showing the gas sensor element of the first embodiment sown in FIG. 1.

FIG. 4 is a view for illustrating a method of forming a porous layer using a doctor blade method.

FIG. 5 is a cross sectional view showing a step of drying a porous layer green sheet to be formed into the porous layer for the gas sensor element of the first embodiment shown in FIG. 1.

FIG. 6 is a view for illustrating a method of forming a porous layer, using an extrusion forming method, of a second embodiment according to the present invention.

FIG. 7 is a cross sectional view for illustrating a porous layer green sheet resulting from the forming method of the second embodiment shown in FIG. 6.

FIG. 8 is an illustrative view showing a lattice structure of a mesh body for use in the forming method of the second embodiment shown in FIG. 6.

FIG. 9 is a cross sectional view of a gas sensor element of a third embodiment according to the present invention.

FIG. 10 is a cross sectional view of a gas sensor element of a fourth embodiment according to the present invention.

FIG. 11 is a cross sectional view of a gas sensor element of a fifth embodiment according to the present invention.

FIG. 12 is a cross sectional view of a gas sensor element of a sixth embodiment according to the present invention.

FIG. 13 is a cross sectional view showing a gas sensor element of the related art.

### DETAILED DESCRIPTION OF THE PREFERRED EMBODIMENTS

Now, gas sensor elements of various embodiments and related manufacturing methods according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views. Also in the following,description, description on the same component parts of one embodiment as those of another embodiment is omitted, but it will be appreciated that like reference numerals designate the same component parts throughout the drawings.

While various aspects of the present invention are described below with reference to gas sensor elements, it will be appreciated that the gas sensor elements implementing the present invention may be incorporated in an A/F senor, an O₂ sensor and a NOx sensor, etc.

Further, as used herein, the expression “a porous layer mainly has gas permeability only in a direction substantially perpendicular to a thickness direction” is meant by the fact that the porous layer has gas permeability in a direction substantially perpendicular to the thickness direction and no gas permeability in the thickness direction of the porous layer or has extremely less gas permeability than that of the porous layer in the direction substantially perpendicular to the thickness direction thereof.

### First Embodiment

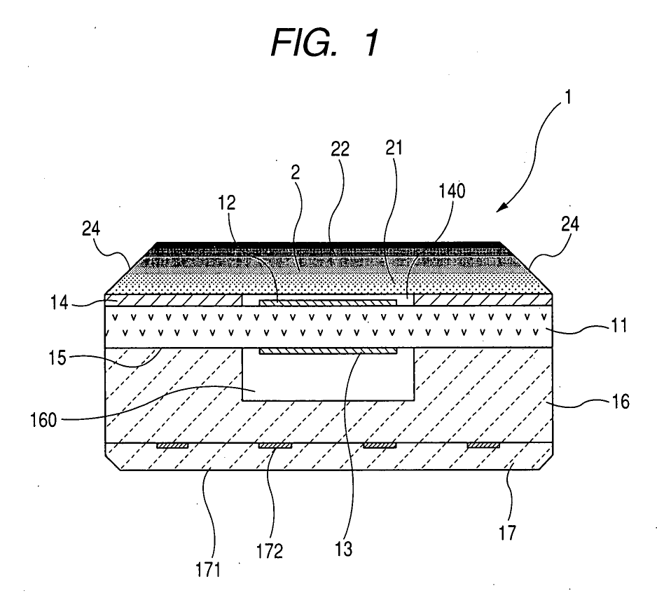

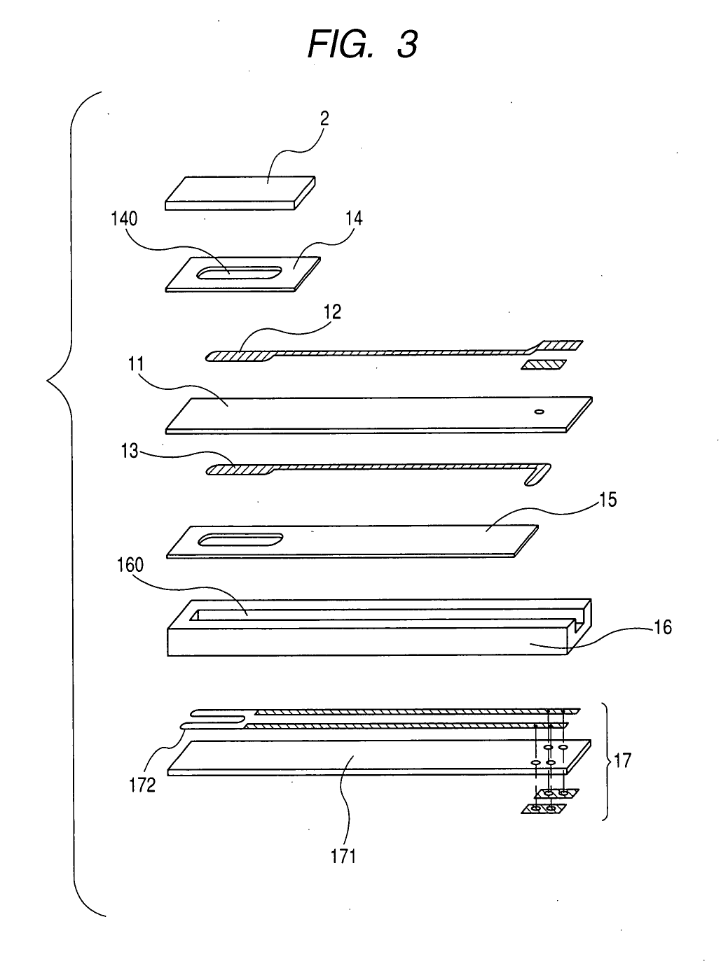

Now, a gas sensor element and a related manufacturing method of a first embodiment according to the present invention are described below in detail with reference to FIGS. 1 to 5.

As shown in FIG. 1, the gas sensor element 1 of the present embodiment comprises a plate-like solid electrolyte body 11, composed of zirconium having oxygen ion conductivity, which has one surface formed with a measuring gas detecting electrode 12 and the other surface formed with a reference gas detecting electrode 13 formed in an area in opposition to the measuring gas detecting electrode 12.

The gas sensor 1 further comprises a measuring gas chamber forming layer 14, formed on the one surface of the solid electrolyte body 13 in an area around the measuring gas detecting electrode 12, and a porous layer 2 that covers the measuring gas detecting electrode 12. Thus, the measuring gas chamber forming layer 14 is sandwiched between the solid electrolyte body 11 and the porous layer 2.

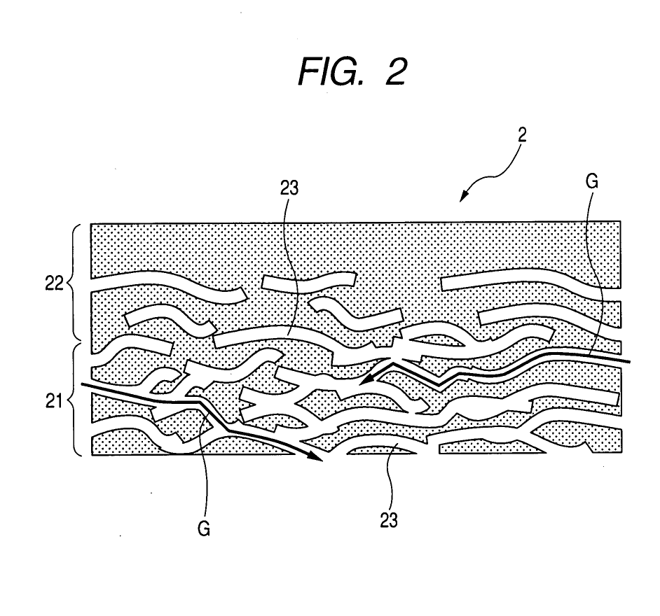

As shown in FIG. 2, the porous layer 2 comprises a coarse layer 21 with high porosity rate, placed closer to the solid electrolyte body 11, and a dense layer 22 having a porosity rate lower than that of the coarse layer 21 and formed in an area remote from the solid electrolyte body 11. The dense layer 22 has the porosity rate less than 5% and the coarse layer 21 has the porosity rate ranging from 5 to 20%.

In addition, the porous layer 2 mainly has gas permeability directed only in a direction substantially perpendicular to a thickness direction of the porous layer 2.

The gas sensor element 1 of the present embodiment may play a role as an A/F sensor element with a voltage applied across the measuring gas detecting electrode 12 and the reference gas detecting electrode 13.Under such a state, electric current flows through both the electrodes, thereby detecting a specified gas (oxygen) concentration in measuring gases (exhaust gases). Moreover, the porous layer 2 serves as a diffusion resistance layer that permeates measuring gases under a difflused state to regulate a rate of measuring gases being supplied to the measuring gas detecting electrode 12.

The measuring gas chamber forming layer 14 is laminated between the solid electrolyte body 11 and the porous layer 2, as already mentioned above, such that a measuring gas chamber 140 is formed in face-to-face relation to the measuring gas detecting electrode 12.

Further, a duct forming layer 16 is stacked on the other surface, formed with the reference gas detecting electrode 13, of the solid electrolyte body 11 via an alumina insulation plate 15. The duct forming layer 16 has one surface formed with a reference gas chamber 160 in face with the reference gas detecting electrode 13.

Furthermore, a heater 17 is stacked on the other surface of the duct forming layer 16 and includes a heater substrate 171 carrying thereon a plurality of heating elements 172 in contact with the other surface of the duct forming layer 16.

With the gas sensor element 1, the porous layer 2 acting as the diffusion resistance layer allows the measuring gas chamber 140 to communicate with measuring gas atmosphere present in an area outside the gas sensor element 1 for permeating measuring gases to the measuring gas chamber 140. When this takes place, the porous layer 2 has diffusion resistance for measuring gases to permeate. Adjusting such diffusion resistance enables the gas sensor element 1 to have a desired limiting current characteristic.

As shown in FIG. 2, the porous layer 2 has a large number of pores 23. The pores 23 are mainly present in the coarse layer 21 at a high incidence rate and formed in elongated configurations substantially perpendicular to the thickness direction of the porous layer 2. In addition, the pores 23 are formed in the porous layer 2 in a pattern contiguous to each other and continuously formed in succession along a direction substantially perpendicular to the thickness direction of the porous layer 2.

With the pores formed in such a particular pattern, the porous layer 2 can permeate measuring gases in a direction substantially perpendicular to the thickness direction of the porous layer 2.

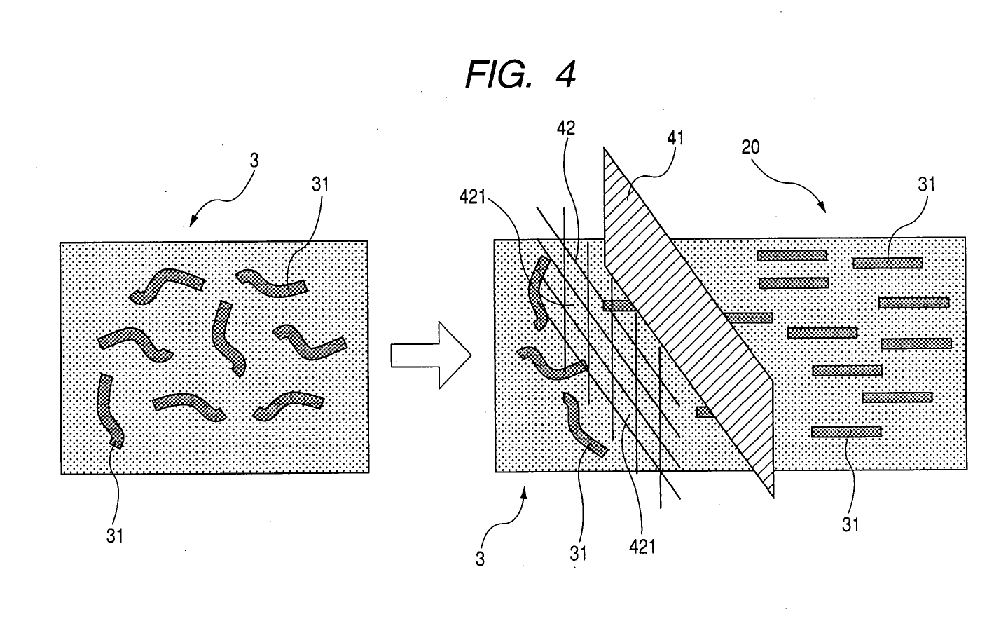

In forming the porous layer 2, fibrous organic materials 31 are mixed to liquid to form porous layer forming slurry 3 as shown in FIG. 4. Thus, a porous layer green sheet 20 is formed using porous layer forming slurry 3 by a doctor blade method. In subsequent step, the porous layer green sheet 20 is fired while causing the fibrous organic materials to be burned down. This allows the pores 21 to be formed in areas where the fibrous organic materials 31 were present before firing, thereby obtaining the porous layer 2 formed with the pores 23 distributed in a particular pattern as set forth above.

As shown in FIG. 4, when forming the porous layer green sheet 20 through the use of the doctor blade method, porous layer forming slurry 3 is formed in a sheet-like configuration using a doctor blade 41. Before conducting such forming step using the doctor blade 41, porous layer forming slurry 3 is caused to pass through a mesh body 42. This allows the fibrous organic materials 31 to be oriented in a direction substantially perpendicular to the thickness direction of the porous layer green sheet 20.

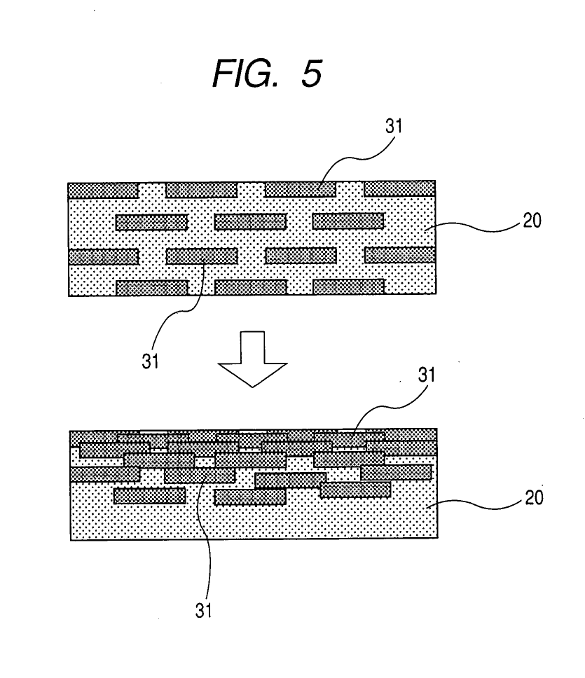

Immediately after the porous layer green sheet 20 has been formed, the fibrous organic materials 31 is distributed in porous layer forming slurry 3 in a substantially uniform fashion. Thereafter, porous layer forming slurry 3 is dried and, during such drying step, the fibrous organic materials 31 prevail in an upper area and concentrates on an upper side of a sheet as shown in FIG. 5. This is due to the fact that the fibrous organic materials 31 have specific gravities less than those of ceramic solids contained in porous layer forming slurry 3 and the ceramic solids are settled down in a lower area during a drying period.

Then, the porous layer green sheet 20 is laminated on a structural frame member 11 via the measuring gas detecting electrode 14 to form an unburned laminate body thereon, after which the porous layer green sheet 20 is fired. During such firing step, the fibrous organic materials 31 are burned down, resulting in the formation of the porous layer 2 having the pores 23. The porous layer 2 has one area, placed in a downside position during drying step, which is formed with the dense layer 22, and another area, placed in an upside position, which is formed with the coarse layer 21. Accordingly, when laminating the porous layer 2 on the measuring gas chamber forming layer 14, the porous layer 2 is laminated on the measuring gas chamber forming layer 14 such that the porous layer 2, taking the upside area during drying step, is placed in face-to-face relation with the solid electrolyte body 11.

Now, the operation and advantages of the gas sensor element 1 are described below in detail.

The porous layer 2 has the coarse layer 21 in an area closer to the solid electrolyte body 11 and the dense layer 22 in the other area remoter from the solid electrolyte body 11 than the coarse layer 21. This enables the porous layer 2 to block off measuring gases from intruding the porous layer 2 in a thickness direction thereof while permitting the porous layer 2 to permeate measuring gases from sidewalls 24 of the porous layer 2.

In particular, the porous layer 2 mainly has gas permeability oriented only in a direction substantially perpendicular to the thickness direction of the porous layer 2. That is, the porous layer 2 has gas permeability in a direction substantially perpendicular to the thickness direction of the porous layer 2 and gas impermeability or extremely less gas permeability than that of the porous layer 2 in the direction substantially perpendicular to the thickness direction.

Therefore, the porous layer 2 is capable of keeping a substantially fixed diffusion distance, as designated by an arrow G shown in FIG. 2, for measuring gases to reach to the measuring gas detecting electrode 12. Accordingly, it becomes possible to obtain the gas sensor element 1 that is capable of generating a sensor output in a stabilized manner with high precision.

In addition, no need arises for a dense shielding layer (like the shielding layer 95 used in the prior art shown in FIG. 13) to be separately provided on a surface of the porous layer 2 and the porous layer 2 can maintain a substantially fixed diffusion distance for measuring gases to reach to the measuring gas detecting electrode 12. This results in capability of achieving a reduction in the number of manufacturing steps and material costs.

Further, the dense layer 22 has porosity less than 5% and the coarse layer 23 has porosity ranging from 5 to 20%. This allows measuring gases to be adequately blocked from penetrating the porous layer 2 in the thickness direction thereof, adequately ensuring the introduction of measuring gases from the sidewalls 24 of the porous layer 2.

Furthermore, in actual practice, water droplets coming with measuring gases are probable to adhere to a surface of the gas sensor element 1. However, an outer surface of the porous layer 2 to which the water droplets adhere is structured with the dense layer 22 having increased strength. Therefore, the gas sensor element 1 can have increased thermal chock resistance and withstand any of thermal shocks resulting from the adhesion of water droplets, thereby effectively preventing the occurrence of cracking in the gas sensor element 1. Thus, it becomes possible for the gas sensor element 1 with excellent durability to be obtained.

Moreover, in the method of manufacturing the gas sensor element 1, porous layer forming flurry 3 is prepared by mixing the fibrous organic materials 31 and using the doctor blade method enables the formation of porous layer forming slurry 3 into the porous layer green sheet 20. This allows a major proportion of the fibrous organic materials 31 to be oriented in the same direction as that in which slurry flows, that is, in a direction substantially perpendicular to the thickness direction of the porous layer green sheet 20. Under such a status, the porous layer green sheet 20 is fired to burn down the fibrous organic materials 31. This results in a consequence with the porous layer 2 formed with the pores 23 in areas where the fibrous organic materials 31 were present. Thus, many of the pores 23 are formed in elongated shapes along a direction substantially perpendicular to the thickness direction of the porous layer 2.

This results in a consequence with the porous layer 2 having gas permeability only in a direction substantially perpendicular to the thickness direction. Thus, it becomes possible to obtain the gas sensor element 1 having increased precision with excellent durability without a need for providing a separate shielding member, thereby providing an ease of production with a reduction in material costs.

Further, in forming the porous layer green sheet 20, porous layer forming slurry 3 is caused to pass through the mesh body 42 to allow the fibrous organic materials 31 to be oriented in a direction substantially perpendicular to the thickness direction of the porous layer green sheet 20. This results in capability of easily and reliably forming the porous layer 2 that mainly has gas permeability only in a direction substantially perpendicular to the thickness direction.

As set forth above, the present invention enables the provision of a gas sensor element with excellent durability and increased precision and related manufacturing method that make it possible to provide an ease of production with a reduction in material costs.

### Second Embodiment

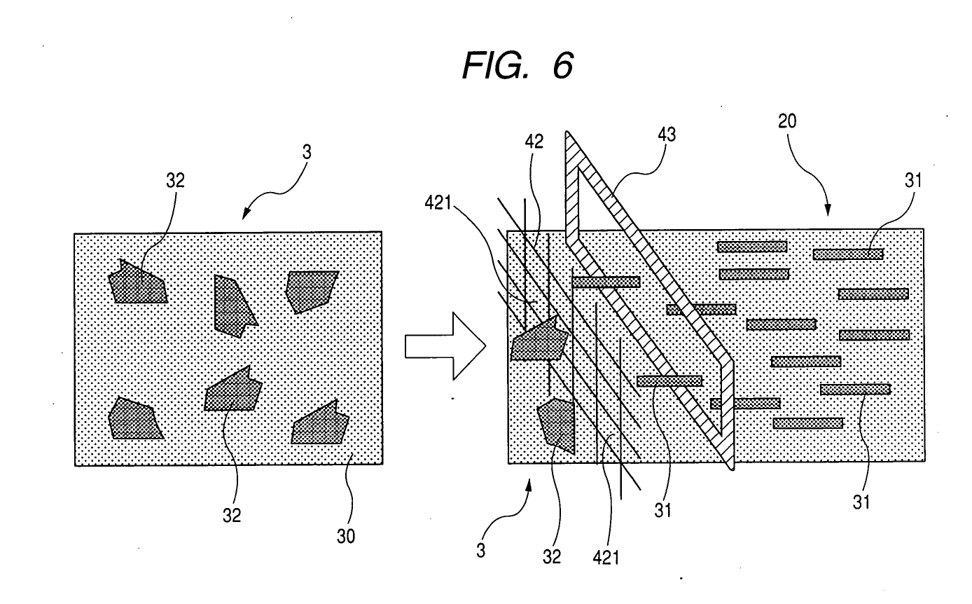

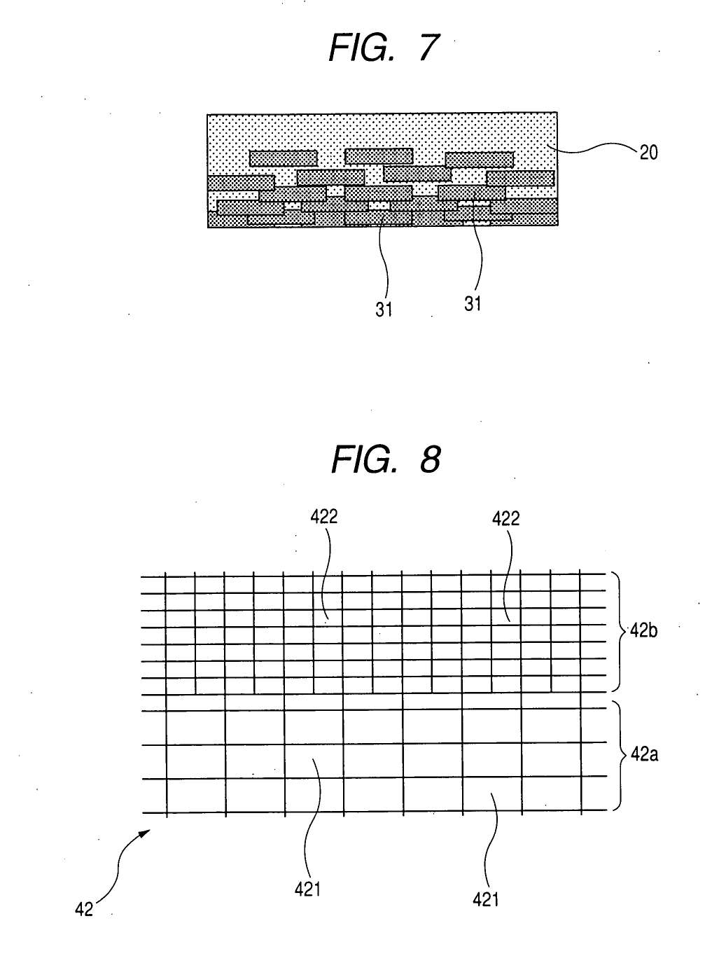

A method of manufacturing a gas sensor element of a second embodiment according to the present invention is described below with reference to FIGS. 6 to 8.

As shown FIGS. 6 to 8, the gas sensor element is manufactured by forming the porous layer green sheet 20 using an extrusion forming method.

More particularly, in forming the porous layer 2, binders in porous layer forming slurry 3 are solidified on initial step as shown in FIG. 6, thereby forming solidified organic materials 32. That is, by applying additives to porous layer forming slurry 3, the binders are solidified into a plurality of solidified organic materials 32.

In next step, porous layer forming slurry 3 is dried and kneaded into a green clay body 30. Then, the solidified organic materials 32 are processed in fibrous shapes to form fibrous organic materials 31. Extrusion forming the green clay body 30 allows the porous layer green sheet 20 to be formed.

Subsequently, the porous layer green sheet 20 is fired while causing the fibrous organic materials 31 to burn down.

As shown in FIG. 6, in forming the porous layer green sheet 20 using such an extrusion forming method, porous layer forming slurry 3 is caused to pass through a shaping die 43 and formed into a sheet-like configuration. Prior to conducting such shaping step, porous layer forming slurry 3 is fed to and passes through the mesh body 42. This allows the solidified organic materials 32, present in the green clay body 30, to be processed in the fibrous configurations into the fibrous organic materials 31, while causing the fibrous organic materials 31 to be oriented in a direction substantially perpendicular to the thickness direction of the porous layer green sheet 20.

Further, as shown in FIG. 8, the mesh body 42 includes first and second areas formed with a coarse grating section 42a and a dense grating section 42b, respectively, which are contiguous to each other on the same plane. The coarse grating section 42a is comprised of a plurality of coarse gratings 421, 421 that are formed in the first area, that is, a lower area of the mesh body 42 as viewed in FIG. 8. In addition, the dense grating section 42b is comprised of a plurality of dense gratings 422, 422 that are formed in the second area, that is, an upper area of the mesh body 42 as viewed in FIG. 8.

The mesh body 42, formed in such a structure, results in capability of forming the fibrous organic materials 31 in altered diameters in the thickness direction of the sheet. That is, the mesh body 42 enables the porous layer green sheet 20 to be formed in structure having a lower area including the fibrous organic materials 31 with increased diameters and an upper area including the fibrous organic materials 31 with decreased diameters.

Thereafter, the porous layer green sheet 20 is fired and the fibrous organic materials 31 are caused to burn down. When this takes place, the areas, in which the fibrous organic materials 31 having small diameters were present, disappear with a grain growth of ceramic particles occurring during firing step. Or even if these areas remain as pores, such pores are merely present as isolated pores cut off from the surrounding pores.

Meanwhile, upon completion of firing step, the other areas, in which the fibrous organic materials 31 having large diameters were present, remain as pores 23 with adequately large sizes which are contiguous to the surrounding pores 23 in fluid communication to permeate measuring gases therethrough.

The manufacturing method of the present embodiment is carried out in the same other steps as those of the manufacturing method of the first embodiment set forth above.

Even with the manufacturing method of the present embodiment, the porous layer 2, resulting from firing step, is formed with the pores 23 in the areas where the fibrous organic materials 31 were present, and many of the pores 23 are formed in elongated shapes in a direction in which the extrusion forming is conducted, that is, along a direction substantially perpendicular to the thickness direction of the porous layer 2. Therefore, the resulting porous layer 2 mainly has gas permeability only in a direction substantially perpendicular to the thickness direction. This results in capability of obtaining a gas sensor element, available to be easily fabricated with a reduction in material costs, which has excellent durability with increased precision.

In addition, when forming the porous layer green sheet 20, porous layer forming slurry 3 is caused to pass through the mesh body 42. This enables the solidified organic materials 32, contained in the green clay body 30, to be easily formed into the fibrous organic materials 31 in a structure with the fibrous organic materials 31 oriented in a direction substantially perpendicular to the thickness direction of the porous layer green sheet 20. Therefore, the porous layer 2 can be easily and reliably fabricated in a structure mainly having gas permeability only in a direction substantially perpendicular to the thickness direction of the porous layer 2.

The manufacturing method of the present embodiment has the same other advantages as those mentioned with respect to the first embodiment.

### Third Embodiment

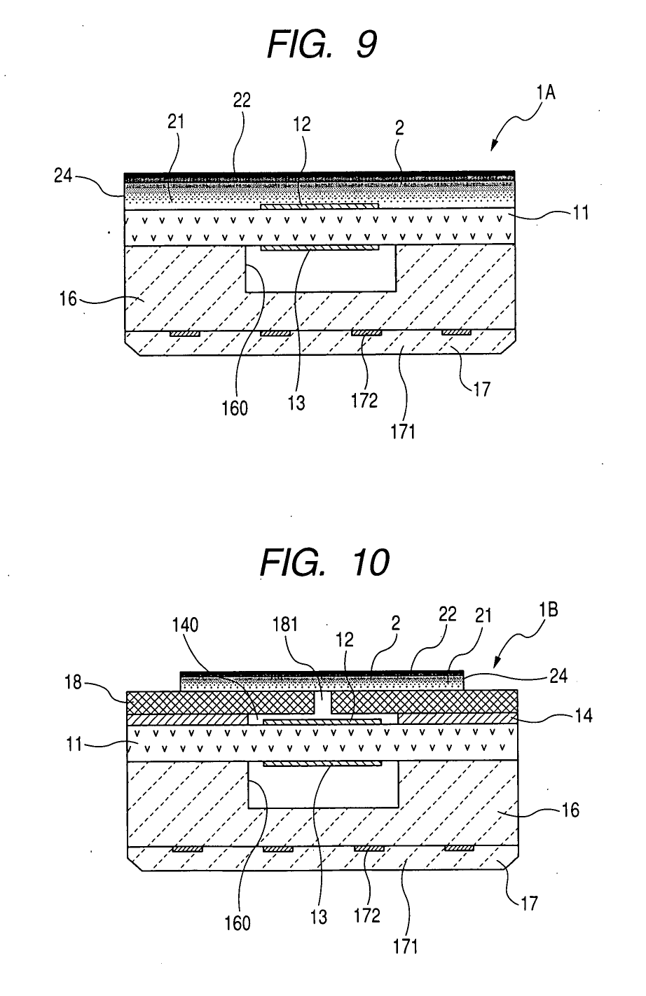

A gas sensor element of a third embodiment according to the present invention is described below with reference to FIG. 9 and shown therein as having the porous layer 2 as a protective layer for capturing toxic substances contained in measuring gases and protecting the measuring gas detecting electrode 12.

In particular, the gas sensor element 1A plays a role as an O₂ sensor in which a voltage is applied across the measuring gas detecting electrode 12 and the reference gas detecting electrode 13 for detecting an oxygen concentration in measuring gases depending on an electromotive force caused on a difference between oxygen concentrations appearing on these electrodes. In addition, the porous layer 2 is formed on the solid electrolyte body 11 as a protective layer so as to cover the measuring gas detecting electrode 12.

The gas sensor element 1A of the present embodiment differs from the gas sensor element 1, shown in FIG. 1, in that the gas sensor element 1A has no air space (measuring gas chamber 140) formed between the porous layer 2 and the solid electrolyte body 11 and the porous layer 2 is held in direct contact with the measuring gas detecting electrode 12.

The porous layer 2 has the same structure as that of the porous layer 2 forming the gas sensor element 1 of the first embodiment shown in FIG. 1.

The gas sensor element 1A of the present embodiment has the same other structure as that of the gas sensor element 1 shown in FIG. 1 and, hence, description of the same is herein omitted for the sake of simplicity.

The gas sensor element 1A of the present embodiment has advantageous effects described below.

Even with the gas sensor element 1A of the present embodiment, the porous layer 2 has the same structure as that of the porous layer 2 of the gas sensor element 1 of the first embodiment. More particularly, the porous layer 2 has the coarse layer 21 in the area closer to the solid electrolyte body 11 and the dense layer 22 in the other area remote from the solid electrolyte body 11. Therefore, the gas sensor element 1A can prevent the occurrence of clogging resulting from toxic substances contained in measuring gases permeating through the porous layer 2. That is, since the porous layer 2 does not introduce measuring gases in the thickness direction of the porous layer 2 but introduce the same from the sidewalls 24 thereof, the accumulation of toxic substances contained in measuring gases can be avoided, enabling the prevention of clogging in the porous layer 2. This enables the provision of a gas sensor element with excellent durability.

### Fourth Embodiment

A gas sensor element 1B of a fourth embodiment according to the present invention is described below with reference to FIG. 10 and shown therein as having a diffusion resistance layer 18 interposed between the porous layer 2 and the measuring gas chamber forming layer 14.

The diffusion resistance layer 18 is made of a dense ceramic sheet having a central area formed with a pinhole 181. The pinhole 181 may be formed in various sizes or the number of pinholes 181 may be selected for regulating diffusion resistance of the diffusion resistance layer 18.

The porous layer 2 is laminated on the diffusion resistance layer 18 so as to cover the pinholes 181

Here, the porous layer 2 has the same structure as that of the porous layer forming part of the gas sensor element 1 of the first embodiment shown in FIG. 1 and is laminated on the diffusion resistance layer 18 with the coarse layer 21 placed in close proximity to the diffusion resistance layer 18.

With such a structure of the gas sensor element 1B, measuring gases are introduced from the sidewalls 24 of the porous layer 2 and reach the pinhole 181, from which measuring gases are introduced to the measuring gas chamber 140.

The gas sensor element 1B has the same other structure as that of the gas sensor element 1B of the first embodiment shown in FIG. 1.

The gas sensor element 1B has the same advantageous effects as those of the gas sensor elements of the first and third embodiments.

### Fifth Embodiment

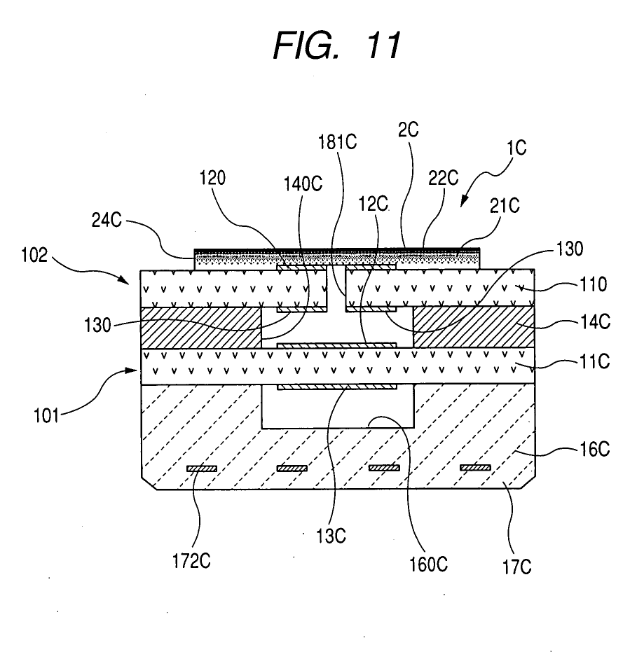

A gas sensor element 1C of a two-cell type of a fifth embodiment according to the present invention is described below with reference to FIG. 11.

As shown in FIG. 11, the gas sensor element 1C of the present embodiment comprises a cell sensor 101 and a pump cell 102 formed in a stacked structure. The sensor sell 101 comprises a first solid electrolyte body 11C, having one surface formed with a measuring gas detecting electrode 12C and the other surface formed with a reference gas detecting electrode 13C formed in opposition to the measuring gas detecting electrode 12C, and a duct forming layer 16C stacked on the other surface of the first solid electrolyte body 11C and having a heater section 17C incorporating therein a plurality of seating elements 172C. The duct forming layer 16C has a central area, facing the other surface of the first solid electrolyte body 11C, which is formed with a duct in the form of a reference gas chamber 160C to which the reference gas detecting electrode 13C is exposed.

The pump cell 102 comprises a second solid electrolyte body 110, having one surface formed with a first pumping electrode 120 and the other surface formed with a second pumping electrode 130 formed in opposition to the first pumping electrode 120, and a measuring gas chamber forming layer 140C, having a central area formed with a measuring gas chamber 140C, which is sandwiched between the first and second solid electrolyte bodies 11C, 110. A pinhole 181C extends through the first and second pumping electrodes 120, 130 and the second solid electrolyte body 110 in communication with the measuring gas chamber 140C. The pinhole 181C provides fluid communication between the measuring gas chamber forming layer 140C, defined between the sensor cell 101 and the pump cell 102, and measuring gas atmosphere in an area outside the gas sensor element 1C.

The pump cell 102 further comprises a porous layer 2C laminated on the one surface of the second solid electrolyte body 110 as a protective layer so as to cover the pinhole 181C.

Here, the porous layer 2C has the same structure as that of the porous layer 1 forming part of the gas sensor element 1 of the first embodiment shown in FIG. 1. With the gas sensor element 1C of the present embodiment shown in FIG. 11, the porous layer 2C has a coarse layer 21C laminated on the one surface of the second electrolyte body 110 in face-to-face relation thereto like the gas sensor element 1 of the first embodiment.

This allows measuring gases to be introduced from sidewalls 24C of the porous layer 2C, upon which measuring gases pass through the pinhole 181C into the measuring gas chamber 140C.

Further, the pump cell 102 operates so as to expel oxygen from the measuring gas chamber 140 to the outside through the solid electrolyte body 110 or introduce oxygen from the outside to the measuring gas chamber 140 for thereby controlling an oxygen concentration in the measuring gas chamber 140.

The gas sensor element 1C operates in the same other fashion as that of the gas sensor element 1 of the first embodiment.

In addition, the gas sensor element 1C has the same other advantages as those of the gas sensor element 1 of the first embodiment.

### Fifth Embodiment

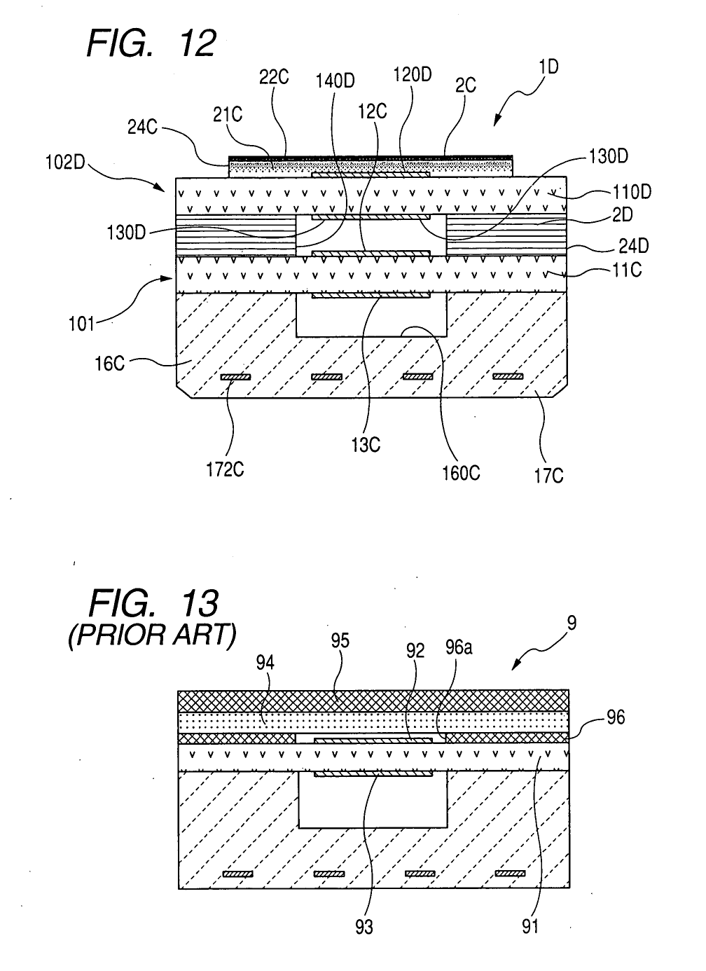

A gas sensor element 1D of a sixth embodiment according to the present invention with a structure including the sensor cell 101 and a pump cell 102D is described below with reference to FIG. 12.

As shown in FIG. 12, the gas sensor element 1D of the present embodiment differs from the gas sensor element 1C shown in FIG. 11 in that no pinhole 181C is formed in a solid electrolyte 110D and a measuring gas detecting electrode 120D and a reference gas detecting electrode 130D. In addition, a diffusion resistance layer 2D, including the porous layer 2 mentioned above, is interposed between the first solid electrolyte body 11C and the second solid electrolyte 102D. The diffusion resistance layer 2D has a central area formed with a measuring gas chamber 140D to which a pumping electrode 130D and the measuring gas detecting electrode 12C are exposed.

The porous layer 2C, forming the diffusion resistance layer 2D, has a structure mainly having gas permeability in a direction substantially perpendicular to the thickness direction. This allows measuring gases to be introduced from sidewalls 24D of the diffusion resistance layer 2D to the measuring gas chamber 140D.

The gas sensor element ID has the same other structure as that of the gas sensor element 1C of the fifth embodiment, shown in FIG. 11, and the same other advantages as those of the gas sensor element 1C of the fifth embodiment.

In summary, the gas sensor elements of various embodiments according to the present invention have various features as mentioned above. As one of these features, the dense layer may have porosity less than 5% and the coarse layer has porosity laying in a value ranging from 5 to 20%.

With such a structure, the porous layer is effective to adequately block the entry of measuring gases in the thickness direction of the porous layer, while ensuring measuring gases to be introduced from the sidewall of the porous layer.

With the dense layer having porosity exceeding 5%, a risk takes place for the porous layer to be hard to adequately block the entry of measuring gases in the thickness direction of the porous layer. Further, with the coarse layer having porosity less than 5%, there is a risk for the porous layer to be hard to feed measuring gases to the measuring gas detecting electrode at an adequate supply rate. On the contrary, with the coarse layer having porosity exceeding 20%, the porous layer becomes hard to exhibit adequate functions such as diffusion resistance in the porous layer and capability of capturing toxic substances in measuring gases.

Further, the porous layer may include a diffusion resistance layer that permeates the measuring gases in a diffused state and adjusts a supply rate of the measuring gases to be fed to the measuring gas detecting electrode.

Such a structure enables the provision of a gas sensor element that is stabilized in sensor output and has high detecting precision. That is, the porous layer (the diffusion resistance layer) blocks the entry of measuring gases in the thickness direction, enabling a substantially fixed diffusion distance to be maintained for measuring gases to reach the measuring gas detecting electrode. This results in stabilized sensor output, enabling the provision of a gas sensor element that has increased detecting precision.

In addition, the diffusion distance for measuring gases to travel can be kept in a substantially fixed value without additionally providing a separate dense shielding layer on a surface of the porous layer (the diffusion resistance layer), enabling a reduction in the number of man-hour and material costs.

Moreover, in such a case, the gas sensor element can act as an A/F sensor element.

Moreover, the porous layer may act as a protective layer that captures toxic substances in the measuring gases to protect the measuring gas detecting electrode.

Such a structure enables the provision of a gas sensor element that has increased durability. That is, as mentioned above, the porous layer (the diffusion resistance layer) allows measuring gases to be introduced not from the thickness direction but from the sidewall. Thus, the accumulation of toxic substances contained in measuring gases can be prevented, preventing clogging from taking place in the porous layer. This results in capability of obtaining a gas sensor element that has increased durability.

Moreover, with such a structure, the gas sensor element can play a role as an O₂ sensor or a NOx sensor.

In the method of manufacturing the gas sensor element, the porous layer green sheet may be formed by a doctor blade method.

With such a doctor blade method, many of the fibrous organic materials, contained in the porous layer forming slurry, are oriented in a direction in which the slurry flows, that is, in a direction substantially perpendicular to the thickness direction of the porous layer green sheet. Therefore, burning down the fibrous organic materials during firing step results in the formation of pores many of which take the elongated configurations oriented in directions substantially perpendicular to the thickness of the porous layer. This results in capability of easily obtaining the porous layer that mainly has gas permeability only in the direction substantially perpendicular to the thickness direction of the porous layer.

In the method of manufacturing the gas sensor element, the porous layer green sheet forming step may include the steps of passing the porous layer green sheet forming slurry through a mesh body to cause the fibrous organic materials to be oriented in the direction substantially perpendicular to the thickness direction of the porous layer green sheet.

With such a manufacturing method, it becomes possible to easily and reliably form the porous layer having gas permeability only in a direction substantially perpendicular to the thickness direction of the porous layer.

In the method of manufacturing the gas sensor element, the step of shaping the porous layer green sheet may be performed using an extrusion forming method.

With such a manufacturing method, many of the fibrous organic materials in the porous layer forming slurry may be oriented in an extruding direction, that is, in a direction substantially perpendicular to the thickness direction of the porous layer green sheet. Therefore, as the fibrous organic materials are caused to burn down to form a large number of pores during the step of firing the porous layer green sheet. When this takes place, many of the pores take the elongated configurations oriented in directions substantially perpendicular to the thickness direction of the porous layer. This results in an ease of obtaining the porous layer that mainly has gas permeability only in the direction substantially perpendicular to the thickness direction.

Further, in the method of manufacturing the gas sensor element, the step of processing the solidified organic materials into the fibrous organic materials may comprise the steps of passing the porous layer forming slurry through a mesh body to form the fibrous organic materials such that the fibrous organic materials are oriented in a direction substantially perpendicular to the thickness direction of the porous layer green sheet.

With such a manufacturing method, it becomes possible to obtain the porous layer that mainly has gas permeability only in the direction substantially perpendicular to the thickness direction.

In the method of manufacturing the gas sensor element, the porous layer may have a coarse layer with large porosity and a dense layer having porosity less than that of the coarse layer.

With such a manufacturing method, the porous layer having the coarse layer with large porosity and the dense layer with less porosity enables measuring gases to travel in a substantially fixed diffusion distance. This allows the porous layer to have increased capacity of capturing toxic substances in measuring gases with the resultant increase in durability of the gas sensor element.

While the specific embodiment of the present invention has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

Although the present invention has been described with reference to the various embodiments directed to the gas sensor elements formed in flat type structures, it will be appreciated that the particular arrangements disclosed are meat to be illustrative only and not limiting to the scope of the present invention. That is, the present invention can be implemented in other specific forms. For instance, the solid electrolyte body and the porous layer may be formed in cylindrical configurations to allow a gas sensor element to be structured in a cylindrical configuration with the outermost layer made of a cylindrical porous layer if desired.

What is claimed is:

1. A gas sensor element comprising:
a solid electrolyte body having oxygen ion conductivity;
a measuring gas detecting electrode formed on one surface of the solid electrolyte body;
a reference gas detecting electrode formed on the other surface of the solid electrolyte body; and
a porous layer covering the measuring gas detecting electrode and permeating measuring gas thereto;
wherein the porous layer includes a coarse layer with a large porosity formed in close proximity to the solid electrolyte body and a dense layer, having a porosity less than that of the porosity of the coarse layer, which is formed in an area away from the coarse layer with respect to the solid electrolyte body.

2. The gas sensor element according to claim 1, wherein:
the dense layer has the porosity less than 5% and the coarse layer has the porosity laying in a value ranging from 5 to 20%.

3. A gas sensor element comprising:
a solid electrolyte body having oxygen ion conductivity;
a measuring gas detecting electrode formed on one surface of the solid electrolyte body;
a reference gas detecting electrode formed on the other surface of the solid electrolyte body; and
a porous layer covering the measuring gas detecting electrode and permeating measuring gas thereto;
wherein the porous layer has gas permeability mainly in a direction substantially perpendicular to a thickness direction of the porous layer.

4. The gas sensor element according to claim 3, wherein:
the porous layer includes a diffusion resistance layer that permeates the measuring gases in a diffused state and adjusts a supply rate of the measuring gases to be fed to the measuring gas detecting electrode.

5. The gas sensor element according to claim 3, wherein:
the porous layer acts as a protective layer that captures toxic substances in the measuring gases to protect the measuring gas detecting electrode.

6. A gas sensor element comprising:
a solid electrolyte body having oxygen ion conductivity;
a measuring gas detecting electrode formed on one surface of the solid electrolyte body;
a reference gas detecting electrode formed on the other surface of the solid electrolyte body;
a duct forming layer formed on the other surface of the solid electrolyte body and having a reference gas chamber to which the reference gas detecting electrode is exposed; and
a porous layer covering the measuring gas detecting electrode and having a coarse layer with a large porosity formed in an area close proximity to the solid electrolyte body and a dense layer, having a porosity less than that of the porosity of the coarse layer, which is formed in another area away from the coarse layer with respect to the solid electrolyte body;
wherein the porous layer has at least one sidewall communicating with the coarse layer and the dense layer through which measuring gases are introduced from an outside measuring gas atmosphere to the measuring gas detecting electrode mainly in a direction substantially perpendicular to a thickness direction of the porous layer.

7. The gas sensor element according to claim 6, wherein:
the dense layer has the porosity less than 5% and the coarse layer has the porosity laying in a value ranging from 5 to 20%.

8. The gas sensor element according to claim 6, wherein:
the dense layer has a central area formed with a measuring gas chamber to which the measuring gases are introduced from the outside measuring gas atmosphere via the coarse layer and the dense layer.

9. The gas sensor element according to claim 6, wherein:
the measuring gas detecting electrode is kept in contact with the coarse layer of the porous layer.

10. A gas sensor element comprising:
a solid electrolyte body having oxygen ion conductivity;
a measuring gas detecting electrode formed on one surface of the solid electrolyte body;
a reference gas detecting electrode formed on the other surface of the solid electrolyte body;
a duct forming layer formed on the other surface of the solid electrolyte body and having a reference gas chamber to which the reference gas detecting electrode is exposed,
a measuring gas chamber forming layer formed on the other surface of the solid electrolyte body and having a measuring gas chamber to which the measuring gas detecting electrode is exposed;
a diffusion resistance layer formed on the measuring gas chamber forming layer; and
a porous layer covering the diffusion resistance layer and having a coarse layer with a large porosity formed in an area close proximity to the diffusion resistance layer and a dense layer, having a porosity less than that of the porosity of the coarse layer, which is formed in another area away from the coarse layer with respect to the diffusion resistance layer;
wherein the porous layer has at least one sidewall communicating with the coarse layer and the dense layer through which measuring gases are introduced from an outside measuring gas atmosphere mainly in a direction substantially perpendicular to a thickness direction of the porous layer; and
wherein the diffusion resistance layer has at least one pinhole providing fluid communication between the coarse layer of the porous layer and the measuring gas chamber to introduce the measuring gases to the measuring gas detecting electrode.

11. The gas sensor element according to claim 10, wherein:
the dense layer has the porosity less than 5% and the coarse layer has the porosity laying in a value ranging from 5 to 20%.

12. A gas sensor element comprising:
a sensor cell including a first solid electrolyte body having oxygen ion conductivity, a measuring gas detecting electrode formed on one surface of the first solid electrolyte body, a reference gas detecting electrode formed on the other surface of the first solid electrolyte body, and a duct forming layer formed on the other surface of the first solid electrolyte body and having a reference gas chamber to which the reference gas detecting electrode is exposed; and
a pump cell stacked on the sensor cell and including a second solid electrolyte body, a first pumping electrode formed on one surface of the second solid electrolyte body, a second pumping electrode formed on the other surface of the second solid electrolyte body, and a measuring gas chamber forming layer interposed between the first and second solid electrolyte bodies and having a measuring gas chamber to which the measuring gas detecting electrode and the second pumping electrode are exposed, and a porous layer formed on the one surface of the second solid electrolyte body so as to cover the first pumping electrode and having a coarse layer with a large porosity formed in an area close proximity to the second solid electrolyte body and a dense layer, having a porosity less than that of the porosity of the coarse layer, which is formed in another area away from the coarse layer with respect to the second solid electrolyte body;
wherein the porous layer has at least one sidewall communicating with the coarse layer and the dense layer through which measuring gases are introduced from an outside measuring gas atmosphere mainly in a direction substantially perpendicular to a thickness direction of the porous layer; and
wherein the second solid electrolyte body has at least one pinhole providing fluid communication between the coarse layer of the porous layer and the measuring gas chamber to introduce the measuring gases to the measuring gas detecting electrode.

13. The gas sensor element according to claim 12, wherein:
the dense layer has the porosity less than 5% and the coarse layer has the porosity laying in a value ranging from 5 to 20%.

14. A gas sensor element comprising:
a sensor cell including a first solid electrolyte body having oxygen ion conductivity, a measuring gas detecting electrode formed on one surface of the first solid electrolyte body, a reference gas detecting electrode formed on the other surface of the first solid electrolyte body, and a duct forming layer formed on the other surface of the first solid electrolyte body and having a reference gas chamber to which the reference gas detecting electrode is exposed; and
a pump cell stacked on the sensor cell and including a second solid electrolyte body, a first pumping electrode formed on one surface of the second solid electrolyte body, a second pumping electrode formed on the other surface of the second solid electrolyte body, and a measuring gas chamber forming layer interposed between the first and second solid electrolyte bodies and having a measuring gas chamber to which the measuring gas detecting electrode and the second pumping electrode are exposed, and a porous layer formed on the one surface of the second solid electrolyte body so as to cover the first pumping electrode and having a coarse layer with a large porosity formed in an area close proximity to the second solid electrolyte body and a dense layer, having a porosity less than that of the porosity of the coarse layer, which is formed in another area away from the coarse layer with respect to the second solid electrolyte body;
wherein the measuring gas chamber forming layer comprises a porous layer having a coarse layer with a large porosity and a dense layer having a porosity less than that of the porosity of the coarse layer and having at least one sidewall communicating with the coarse layer and the dense layer through which measuring gases are introduced to the measuring gas chamber from an outside measuring gas atmosphere mainly in a direction substantially perpendicular to a thickness direction of the porous layer of the measuring gas chamber forming layer.

15. The gas sensor element according to claim 14, wherein:
the dense layer has the porosity less than 5% and the coarse layer has the porosity laying in a value ranging from 5 to 20%.

16. A method of manufacturing a gas sensor element, the method comprising the steps of:
(a) preparing a solid electrolyte body, having oxygen ion conductivity, which has one surface formed with a measuring gas detecting electrode and the other surface formed with a reference gas detecting electrode; and
(b) covering the measuring gas detecting electrode with a porous layer;
wherein the porous layer is formed by forming a porous layer green sheet using a 10 porous layer forming slurry mixed with fibrous organic materials, orienting the fibrous organic materials in a direction substantially perpendicular to a thickness direction of the porous layer green sheet, and firing the porous layer green sheet while burning down the fibrous organic materials.

17. The method of manufacturing the gas sensor element according to claim 16, wherein:
the porous layer green sheet is formed by a doctor blade method.

18. The method of manufacturing the gas sensor element according to claim 16, wherein:
the porous layer green sheet forming step includes the steps of passing the porous layer green sheet forming slurry through a mesh body to cause the fibrous organic materials to be oriented in the direction substantially perpendicular to the thickness direction of the porous layer green sheet.

19. The method of manufacturing the gas sensor element according to claim 16, wherein:
the porous layer has a coarse layer with a large porosity and a dense layer having a porosity less than that of the porosity of the coarse layer.

20. A method of manufacturing a gas sensor element, the method comprising the steps of:
(a) preparing a solid electrolyte body, having oxygen ion conductivity, which has one surface formed with a measuring gas detecting electrode and the other surface formed with a reference gas detecting electrode; and
(b) forming a porous layer so as to cover the measuring gas detecting electrode;
wherein the porous layer forming step (b) includes the steps of:
(c) solidifying binders in a porous layer forming slurry to form solidified organic materials;
(d) drying the porous layer forming slurry and kneading the same to form a green clay body and subsequently processing the solidified organic materials into fibrous organic materials;
(e) shaping the green clay body into a porous layer green sheet to cause the fibrous organic materials to be oriented in a direction substantially perpendicular to a thickness direction of the porous layer green sheet; and
(f) firing the porous layer green sheet while burning down the fibrous organic materials.

21. The method of manufacturing the gas sensor element according to claim 20, wherein:
the step (e) of shaping the porous layer green sheet is performed using an extrusion forming method.

22. The method of manufacturing the gas sensor element according to claim 20, wherein:
the step of processing the solidified organic materials into the fibrous organic materials comprises the steps of:
passing the porous layer forming slurry through a mesh body to form the fibrous organic materials such that the fibrous organic materials are oriented in a direction substantially perpendicular to the thickness direction of the porous layer green sheet.

23. The method of manufacturing the gas sensor element according to claim 20, wherein:
the porous layer has a coarse layer with a large porosity and a dense layer having a porosity less than that of the porosity of the coarse layer.
